(19) United States
(12) Patent Application Publication
(10) Pub. No.: US 2024/0272094 A1
(43) Pub. Date: Aug. 15, 2024

(54) TWO-STAGE PIXEL DEVICE WITH ADAPTIVE FRAME GRABBING FOR X-RAY IMAGING WITH OR WITHOUT AUTOMATIC EXPOSURE CONTROL, AND RELATED SYSTEMS, METHODS AND DEVICES

(71) Applicant: ANALOGIC CANADA CORPORATION, Montreal (CA)

(72) Inventors: Anastasiia Mishchenko, Montreal (CA); François Boucher, Montreal (CA); Luc Laperriere, Montreal (CA)

(21) Appl. No.: 18/260,013

(22) PCT Filed: Dec. 28, 2021
(86) PCT No.: PCT/IB2021/062403

§ 371 Date: Jun. 29, 2023

Related U.S. Application Data
(60) Provisional application No. 63/131,543, filed on Dec. 29, 2020.

(51) Int. Cl. G01N 23/046; G01T 1/29

(52) U.S. Cl. CPC G01N 23/046; G01T 1/2985; G01N 2223/306; G01N 2223/401; G01N 2223/419; G01N 2223/50

(57) ABSTRACT

Disclosed embodiments include an x-ray imaging system and method that includes a radiation source configured to generate radiation directed toward an object. A computing device may be configured to monitor a number of pixels and capture imaging data when at least some of the radiation passes through the object and impinges on the number of detectors enabling adaptive frame grabbing, which may optionally provide image data input for automatic exposure control (AEC) for exposure duration adjustment based on an AEC output. Such systems and methods may significantly simplify system implementation, irrespective of angular range, number of projection views and scan time in tomosynthesis and other three-dimensional x-ray systems, as well as for two-dimensional x-ray scans with variable exposure pulse duration.

### PRIORITY CLAIM

This application is a national phase entry under 35 U.S.C. § 371 of International Patent Application PCT/IB2021/062403, filed Dec. 28, 2021, designating the United States of America and published as International Patent Publication WO 2022/144782 A1 on Jul. 7, 2022, which claims the benefit under Article 8 of the Patent Cooperation Treaty of U.S. Provisional Patent Application Ser. No. 63/131,543, filed Dec. 29, 2020.

### TECHNICAL FIELD

The present disclosure relates generally to imaging. More particularly, embodiments of the present disclosure relate to pixels for use in x-ray imaging systems, and related assemblies, systems, and methods.

### BACKGROUND

Radiation imaging systems provide information, or images, of an object under examination or rather interior aspects of the object. For example, in x-ray imaging systems, the object is exposed to radiation, and one or more images are formed based upon the radiation absorbed by the object, or rather an amount of radiation that is able to pass through the object. Typically, highly dense objects absorb (e.g., attenuate) more radiation than less dense objects, and thus an object having a higher density, such as a bone or gland, for example, will appear differently in an image than less dense objects, such as fatty tissue or skin.

A digital x-ray detector allows x-ray images to be captured digitally. Typically, a digital x-ray detector includes a pixelated array coupled with x-ray sensing material, and digital x-ray system includes a digital x-ray detector coupled to a digital image processor. Digital x-ray systems allow the image to be processed by a computer, for example, to adjust an image's brightness, contrast and optimize the noise. In this way, subtle details, which may be missed by fixed, limited contrast in traditional screen-film x-ray system, can be detected. Thus, digital x-ray systems produce images having greatly enhanced details visibility compared to images obtained by traditional screen-film x-ray; and, there are several other advantages in digital imaging vs. screen film, such as image handling, storing, and capability for computer-aided diagnosis, improved image quality and possible dose reduction. The resolution of digital x-ray images is also greatly enhanced as compared to the resolution of images obtained using other known techniques.

In medicine, x-ray imaging systems are commonly used to detect broken bones, masses, calcium deposits, without limitation, that are not visible to the naked eye. One type of x-ray image system is a mammography unit, which typically includes a radiation source, a collimator, one or more compression paddles, an anti-scatter grid, and an x-ray detector array. The detector array is mounted on a diametrically opposing side of the breast tissue (i.e., an object under examination, also called an “imaging object”) from the radiation source and a compression paddle. In mammography, the radiation source emits ionizing radiation that traverses the breast tissue while it is compressed. Radiation that traverses the breast tissue is then detected by the detector array. In screening mammography, flat panel detectors typically generate, store and read-out x-ray signal, and correction algorithms are used to create one or more two-dimensional images of the imaging object in the latitudinal dimension (e.g., a direction orthogonal to a center x-ray beam and/or substantially parallel to the detector array, without limitation).

While two-dimensional projection x-ray images are useful in mammography and other applications, these images provide little or no resolution in the longitudinal direction (e.g., parallel to the x-ray beam and/or orthogonal to the detector plane formed by the detectors, without limitation). On a breast examination, for example, a two-dimensional, x-ray image cannot provide information about whether a mass in a breast is nearer the radiation source or the detector array. A potentially cancerous mass, for example, may be masked by a dense aspect of the breast, such as a gland, if the mass is on top of the gland or vice versa, for example. Moreover, because objects of interest (e.g., cancerous cells, without limitation) can share similar density information as objects that are not of interest, objects that are not of interest are sometimes mistakenly classified as an object of interest, resulting in a false positive.

Digital tomosynthesis enables a three-dimensional image of an object to be reconstructed from a finite set of two-dimensional projection images of the object by acquiring multiple two-dimensional images from multiple angles, and then reconstituting the data. Using digital tomosynthesis, a certain degree of resolution can be produced in the longitudinal dimension. Typically, in digital breast tomosynthesis systems the x-ray source is rotated during data acquisition, for example, in an arc through a limited angular range, and a set of projection radiographs of the object are acquired by a stationary or tilted detector at discrete locations of the x-ray source along the x-ray source path. In many systems, the digital x-ray detector array and the object are maintained in a stationary or fixed position while the x-ray source is moved to multiple locations in order to obtain a collection of images from different view angles.

The multiple two-dimensional images are synthesized using image reconstruction/processing techniques. A synthesized image may be focused on a tomography plane that is be parallel to the detector plane or may be focused on generating cross-sectional images of an object, e.g., “slices,” in either case located at a certain depth along the longitudinal direction. Generally speaking, the two-dimensional projection images are spatially translated with respect to each other, and superimposed in such a way that the images overlap precisely in the tomography plane. Other methods for reconstructing tomographic images may use sophisticated computation techniques similar to those used in computed tomography systems. The location of the tomography plane within the object can be varied, and a two-dimensional image of the object can be obtained for each location of the tomography plane.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 illustrates an imaging system in accordance with one or more embodiments.

FIG. 2 illustrates a pixel in accordance with one or more embodiments.

FIG. 3 illustrates a pixel matrix in accordance with one or more embodiments.

FIG. 4 illustrates a process in accordance with one or more embodiments.

FIG. 5 illustrates an example frame collection timeline in accordance with one or more embodiments.

FIG. 6 illustrates an example frame monitoring timeline in accordance with one or more embodiments.

FIG. 7 illustrates computing processing in accordance with one or more embodiments.

FIG. 8 illustrates an x-ray delivery process in accordance with one or more embodiments.

FIG. 9 illustrates an example pixel array with a selectable subset of pixels in accordance with one or more embodiments.

### DETAILED DESCRIPTION

The illustrations presented herein are not meant to be actual views of any particular imaging system or component thereof, but are merely idealized representations employed to describe illustrative embodiments. The drawings are not necessarily to scale. Elements common between figures may retain the same numerical designation.

As used herein, relational terms, such as “first,” “second,” “top,” “bottom,” without limitation, are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

As used herein, the term “substantially” or “about” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even 100% met.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be used in this description interchangeably with the term “coupled,” and have the same meaning unless expressly indicated otherwise or the context would indicate otherwise to a person having ordinary skill in the art.

As used herein, “radiation” should generally be understood to mean ionizing radiation; so when an element transmits radiation, radiation is transmitted toward an element, or an element is exposed to radiation, unless otherwise specifically stated, this means and includes ionizing radiation. Ionizing radiation is radiation, traveling as a particle or electromagnetic wave (i.e., a photon), that carries sufficient energy to detach electrons from atoms or molecules, thereby ionizing them, such as x-rays and gamma rays, without limitation.

It should be appreciated that energy per photon and/or a degree of radiation exposure may depend on context. As non-limiting examples, a specific imaging application (e.g., medical screening, medical diagnostic, medical procedure guidance, industrial inspection, security inspection and/or detection, without limitation), an environment in which radiation imaging systems are deployed, and/or regulatory requirements.

A single photon traveling in a specific direction relative to a source of the photon may be referred to herein as a “ray of radiation” or just a “-ray” (e.g., an “x”-ray or a “gamma”-ray, without limitation). A grouping of photons traveling substantially in a direction relative to a source or sources may be referred to herein as a “beam” of radiation or a “radiation beam.” The photons of a radiation beam may carry or have an energy per photon or different energy per photon, that is, a radiation beam may carry and/or deliver energy over a spectrum.

As used herein, the term “pixel” means a detector element. As a non-limiting example, a pixel may include a combination of an x-ray-to-charge converter and electronics for resetting, integrating, storing, and readout of an x-ray generated signal. A detector may, as a non-limiting example, comprise pixels arranged in rows and columns.

X-ray imaging systems are generally used for viewing the interior of an object or objects. For example, x-ray imaging may be used for analyzing the contents of a package, luggage, without limitation, without opening the object. In another example, x-ray imaging may be used to view inside a human or animal to diagnose a problem (e.g., broken bones, internal bleeding, arthritis, cavities, damaged organs, without limitation) or provide early detection of problems (e.g., via cancer screenings, mammograms, without limitation). X-ray imaging systems generally include a radiation source (e.g., an x-ray tube based x-ray generator or a solid-state based x-ray generator, without limitation) and a detector (e.g., photographic plate, X-ray film, image plates, flat panel detectors, without limitation). X-ray imaging systems typically create a two-dimensional image in a plane of the detector. For some applications a single two-dimensional image is sufficient. However, in some applications three-dimensional images or at least images from different angles are desirable or even required to more accurately represent contents of the object and/or patient, for example, to represent the contents in both a lateral and a vertical plane.

X-ray imaging systems may be configured to capture images from different angles of an object that can then be compiled or combined to create a three-dimensional image or representation of the inside of the object through, for example, tomography or other three-dimensional reconstruction methods. One or more of the radiation sources and the x-ray detector may be configured to rotate relative to the object to capture images at different angles (including, as a non-limiting example, with different geometries).

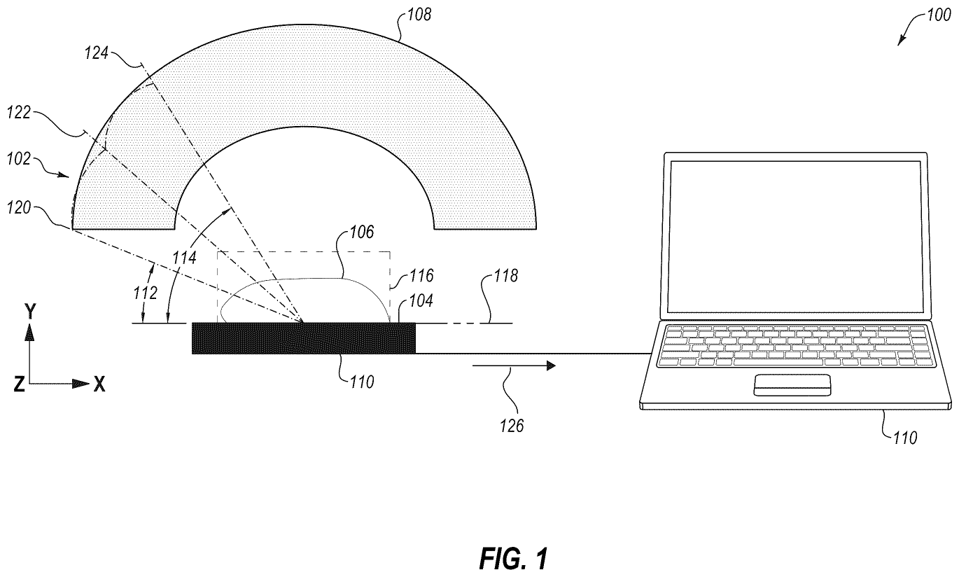

FIG. 1 illustrates an x-ray imaging system 100, according to various embodiments of the disclosure. The x-ray imaging system 100 may include a radiation source 102 configured to supply radiation in continuous or step-and-shoot mode, without limitation, in a direction toward a detector plane 104 that includes an active surface co-planar with plane 118 (plane 118 is depicted by a dashed line in FIG. 1). An object 106 may be positioned between the radiation source 102 and the detector plane 104, such that radiation (e.g., beams of radiation including rays 120, 122 and 124, without limitation) travels from the radiation source 102 through the object 106 to the detector plane 104. The radiation source 102 may be configured to rotate through the arc path 108 defined by, e.g., a gantry, relative to the object 106. In some embodiments, radiation source 102 may be stationary with respect to the object 106 and the detector plane 104. In some embodiments, the detector plane 104 may be configured to rotate relative to the object 106 as well. In some embodiments, the detector plane 104 may be configured to remain stationary relative to the object 106 and the radiation source 102.

Detector plane 104 may include a number of pixels in an array and/or matrix arrangement. Each pixel may be configured to collect and store charge (e.g., which also may be characterized as to integrate charge, without limitation) based on an amount of radiation incident upon each individual pixel. The respective signal generated at each pixel may be amplified and read out (e.g., pixel signal 126) by signal processing circuitry and recorded at computing device 110 (e.g., a computer such as a workstation with a monitor, or a computer based monitoring system, without limitation) to create a digital representation of an image. Amplification stage impacts signal-to-noise ratio and dynamic range of each pixel. The type of x-ray-to-charge-converter used, the size and the shape of the pixels, and pixel arrangement on detector plane 104 define the amount of signal generated per pixel in response to incident beam of radiation, resolution and other important image quality characteristics (e.g., without limitation temporal performance) of the detector plane 104 and may vary. In some embodiments, the pixels may have a size (e.g., pitch) between about 40 μm and about 80 μm, such as between about 48 μm and about 60 μm, between about 48 μm and about 54 μm, or between about 54 μm and about 60 μm, without limitation.

During a contemplated operation of x-ray imaging system 100, radiation source 102 may begin by supplying radiation at an initial angle of incidence 112 relative to an object 106 and/or the detector plane 104. As the radiation source 102 moves relative to the object 106 located in an examination region 116, radiation source 102 may supply radiation at other angles of incidence, such as angle of incidence 114, along arc path 108. While the radiation source 102 radiates the object 106, the pixels of detector plane 104 integrate x-ray-generated charge “seen” during the change in angle of incidence 114.

While specific examples discussed herein include movable radiation sources, disclosed embodiments are not so limited. As a non-limiting example, disclosed radiation sources may include multiple (i.e., two or more) stationary radiation sources, e.g., based on cold cathode technology, without limitation. Such multiple stationary radiation sources may be arranged to supply radiation at different angles of incidence to an object. Such multiple stationary sources may be positioned at locations that are spaced in the x direction or spaced in the x and y direction (when spaced in both x and y direction that may be considered an arc path 108), or locations bunched together with radiation sources facing different directions.

Computing device 110 may observe and record a signal developed on each pixel (e.g., pixel by pixel, groups of pixels, or all of the pixels, without limitation) and non-destructively read (i.e., without erasing a pixel voltage—which may also be characterized as not erasing a pixel signal) or destructively read (i.e., erasing a pixel signal) at specified intervals (e.g., frames) defined by a given frame rate. Computing device 110 may record values representative of one or more charge integrate/read cycles for a pixel.

In some embodiments, the computing device 110 may only observe—read, and/or erase signals for a subset of the number of pixels of detector plane 104 at a given instance (e.g., one pixel, two pixels, three pixels, four pixels, without limitation) or all the pixels. The collection of charges by charge collection electrodes under x-ray converters of one or more pixels between the end of read of previous frame and the read event for the actual frame is referred to herein as an “integration process.” The recording with or without erasing of the pixel signals may be referred to as a destructive or non-destructive “readout process.”

In some embodiments, noise and interference leading to image artefacts may be introduced into an image (e.g., during charge integration, charge storage, signal digitization and readout, without limitation), e.g., due to a difference in solid angle “seen” by each pixel while exposed to radiation during an integration process which also differ in time (e.g., because computing device 110 must read each pixel or row of pixels individually). Additionally, or alternatively, noise and interference may be introduced into an image due to a different solid angle each pixel “has seen” during gantry motion. A difference in time between a time that a first pixel is read and a time that a last pixel is read during an integration process may be but not limited to, between about 20 milliseconds and about 60 milliseconds, such as between about 28 milliseconds and about 55 milliseconds, or between about 20 milliseconds and about 40 milliseconds. Additional integration time between the read of the last pixel and the read of the first one may or may not be introduced, depending on the device implementation and desired frame rate.

In some embodiments, computing device 110 may trigger a scan of a group of pixels row-by-row. Computing device 110 may trigger a row-by-row scan of a group of pixels with a constant delay between rows resulting in a same integration period for each row. A row-by-row scan with a uniform integration period for each row where a single bank is alternately used for readout or integration is referred to herein as a “rolling shutter.” A row-by-row scan with a uniform integration period for each row where one of two banks is used for readout while the other of the two banks is used for integration is referred to herein as a “global shutter.”

In a contemplated operation of a rolling shutter, pixels in each row may be read at substantially the same time. As discussed herein, noise and/or interference in the read operation, for example, due to a delay between a first row read and a last row read. Computing device 110 may globally reset the pixels, all at the same time, after having read all of the pixels in the array. A global reset may provide the same starting point for a next integration period for all of the reset pixels. In some cases, there may still be a difference between a solid angle of a gantry motion as radiation being delivered is “seen” by the pixels—because of the length of time required for the computing device to read through all of the pixels in the array from the first to the last row. The integration period in case of global reset employment will also vary from the first to the last raw and would lead to a gradient artefacts requiring sophisticated correction techniques to flatten the image.

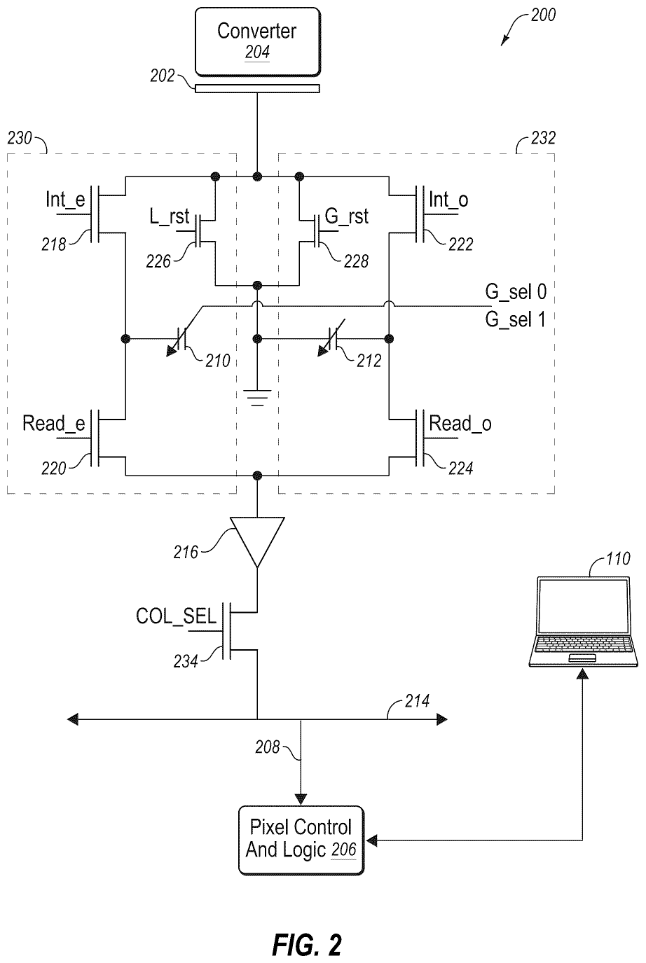

FIG. 2 illustrates a multi-stage (here a two-stage) CMOS pixel architecture, in accordance with one or more embodiments. Among other things, a two-stage CMOS pixel architectures described herein enables pixel 200 to continuously integrate charge at one stage while computing device 110 simultaneously reads, records, and/or resets signal at the other stage.

Pixel 200 (which may also be referred to herein, generally, as a “detector element” or an “imaging element”) is configured, generally, to provide image data (in FIG. 2, pixel signal 208) that is representative of the intensity of an x-ray beam incident upon a location of pixel 200. Converter 204 may be configured to convert the radiation of an x-ray beam into electrical charge in a “direct” or an “indirect” manner (i.e., direct using x-ray photoconductor or indirect using combination of scintillator and a light sensor such as a photodiode, without limitation). In a direct conversion configuration of converter 204, an x-ray photoconductor may be formed from a photoconductive material such as selenium, CZT, PbI2, HgI2, PbO, Perovskite, without limitation. Such a photoconductor may become electrically conductive due to absorption of radiation resulting in charge carriers generation; transition through converter 204 and its subsequent collection under an applied electric field across the photoconductor, through a top electrode over converter 204 (not shown) and charge collection electrode 202, respective to the amount of radiation absorbed.

In an indirect conversion configuration of converter 204, a scintillator converts absorbed radiation to light photons, and a photodetector (e.g., including a phosphor material, without limitation) converts absorbed light into electrical charge (such as a photodiode, without limitation).

Charge may be integrated onto a capacitor 210 and capacitor 212 (both can be programmable capacitors with gain selection) by way of charge collection electrode 202. The collected charge may be converted to voltage, and the voltage may be amplified by gain stage 216 (e.g., a high-gain differential amplifier operated in follower mode, without limitation) and read through a common signal processing circuitry (i.e., shared among a number of pixels, without limitation) via pixel selection device 234. In the embodiment shown in FIG. 2, pixel signal 208 may be read via a common bus, i.e., analog bus 214, by pixel control and logic 206 and recorded at computing device 110. Upon reading or reading/recording charge from capacitor 210/capacitor 212, the capacitor may optionally be reset via respective reset devices, here, reset device 226 or reset device 228 (e.g., using signals L_rst and G_rst, respectively), as the case may be.

After a capacitor is reset (by activating reset device 228 and/or reset device 226), integrating device 218 or integrating device 222, may be turned on via signals Int_e and Int_o, respectively, to allow charging of a capacitor by charge flow through converter 204 and charge collection electrode 202 (in case of direct conversion). Charge may be stored at capacitor 212 or capacitor 210, until, for example, a pixel voltage (i.e., converted to pixel signal 208) is again read and recorded for a next frame.

In the embodiment shown in FIG. 2, pixel 200 includes a first stage 230 and a second stage 232, each of which is separately operable to be coupled to charge collection electrode 202 and/or pixel control and logic 206, such that at a given instant, one of the stages may be operably coupled to charge collection electrode 202 and the other one of the stages may be operably coupled to pixel control and logic 206.

In a contemplated operation of pixel 200, first stage 230 may integrate charge while second stage 232 may be read. Integration at first stage 230 is activated by turning on integrating device 218 (e.g., a transistor, without limitation) via signal Int_e such that charge may be collected at the capacitor 210. Turning on integrating device 222 (e.g., a transistor, without limitation) forms a path from charge collection electrode 202 to be integrated onto capacitor 212.

Reading at second stage 232 is activated by turning on reading device 224 (e.g., readout transistor) via signal Read_o, while integrating device 222 is “off.” Turning on reading device 224 provides a path from capacitor 212 to pixel output buffer, where a signal (i.e., a pixel signal) corresponding to the charge may be amplified at gain stage 216, e.g., by a differential amplifier module, operated in a follower mode and provided to pixel control and logic 206 via analog bus 214.

While the charge is collecting at capacitor 210, computing device 110 may read and record a digitized pixel signal corresponding to pixel signal 208 (which may be converted to voltage). In the contemplated example, pixel signal 208 corresponds to the charge collected at capacitor 212. Upon reading/recording the pixel signal 208 corresponding to the charge collected at capacitor 212, and in preparation for the next X-ray signal integration onto capacitor 212 reset device 226 is turned on, (e.g., when a reset transistor is activated, without limitation), which resets capacitor 212 to a predefined value.

In a next cycle, first stage 230 may be read by turning on reading device 220 via signal Read_e, and pixel signal 208 corresponding to charge collected at capacitor 210 may be read while second stage 232 is integrating, and so on and so forth.

Notably, in an embodiment of a detector plane 104 that includes a number of pixels that are a pixel 200, all pixels that are a pixel 200 of detector plane 104 may be reset at the same time as described herein. Simultaneous reset enables integration of all pixels that are a pixel 200 at the same time (i.e., during the same integration period), and more specifically, integrating information from the same angle of incidence at the same time at multiple pixels that are pixel 200. Moreover, all of the pixels of pixel 200 may continue with a next integration period by utilizing the two charge banks of pixels that are pixel 200, i.e., the charge banks of first stage 230 and second stage 232, one bank used for integration in the next integration period while the other bank is used for readout.

In some embodiments, each capacitor 210 and capacitor 212 may have substantially the same charge capacity. For example, the capacitor 210 and capacitor 212 may have a charge capacity between about 0.05 Pico Coulomb (pC) and about 4 pC, such as between about 1 pC and about 3 pC, between about 1.1 pC and about 1.5 pC, or about 1.2 pC, without limitation.

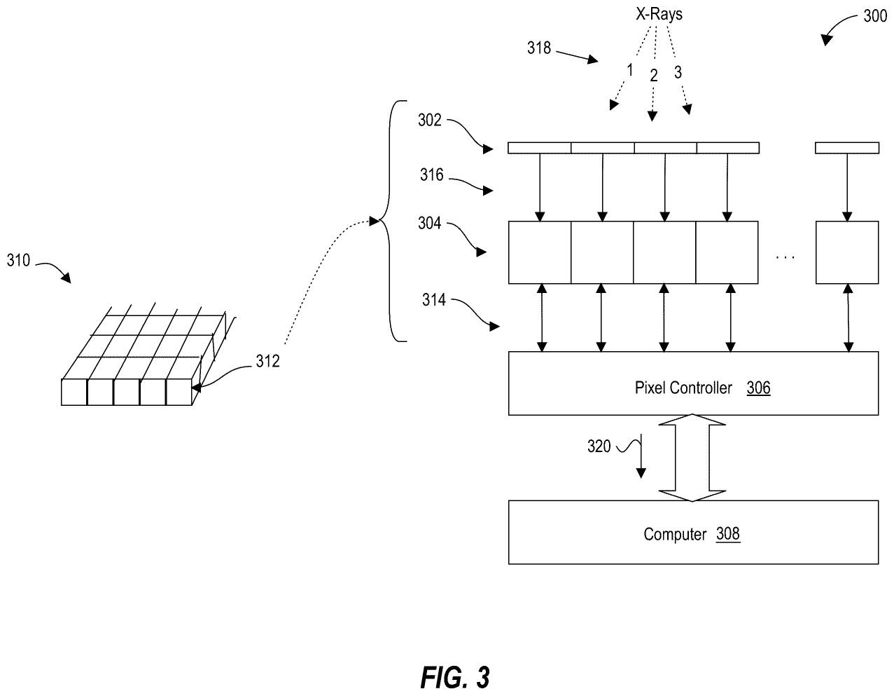

FIG. 3 illustrates a schematic diagram of a pixel matrix 300 of pixels 310, in accordance with one or more embodiments. FIG. 3 depicts a specific non-limiting example where radiation is supplied by a radiation source (moving or by a number of stationary sources) from right to left in the depiction.

Pixel matrix 300 includes a number of pixels 310, each a pixel 200 of FIG. 2, arranged in a row. A sib-diagram of pixel row 312 is depicted to the right of pixels 310. Pixel row 312 includes converters 302, pixels charge 316, pixel controller 306 and computer 308. As depicted by FIG. 3, during a capture of a frame of image data, charge 316 is provided by converter 302 to pixels 304 in response to x-rays 318 interacting with converters 302. While charge 316 is collected at pixels 304, computer 308 reads image data 314 from pixel row 312 (e.g., included in data signals of data and pixel control signals 320). As discussed herein, image data 314 that computer 308 reads may correspond to an immediately previous frame.

After reading all of the rows of pixels 310, including without limitation, pixel row 312, computer 308 may instruct pixel controller 306 to perform a global reset. The control signals of data and pixel control signals 320, in response to the global reset instruction from computer 308, simultaneously activates the reset devices of the pixels 310 of pixel matrix 300, e.g., as described herein.

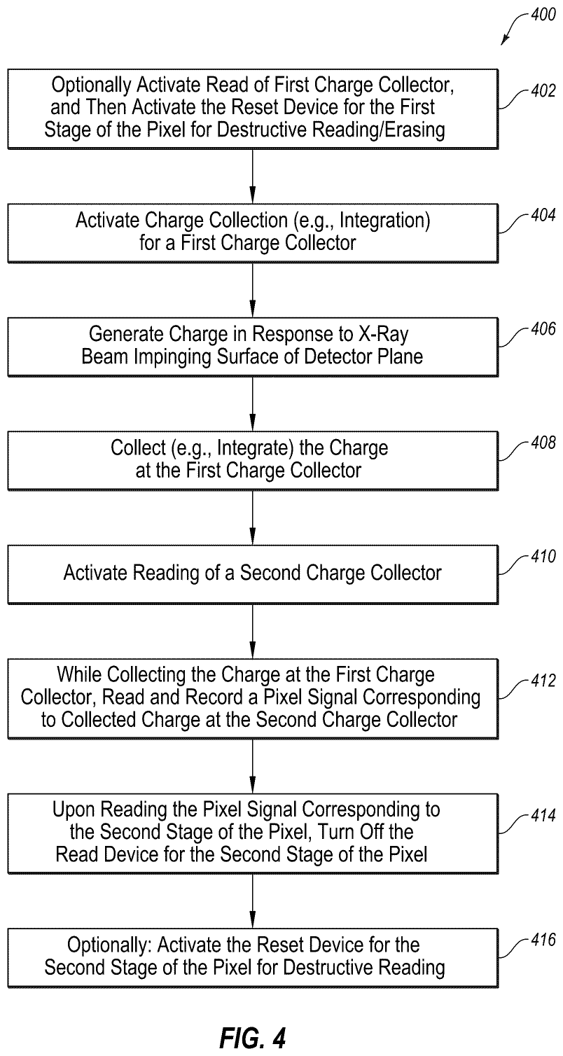

FIG. 4 illustrates a flowchart of a process 400 for acquiring image data from a pixel, including without limitation a pixel 200, in accordance with one or more embodiments.

In operation 402, process 400 optionally reads out and then resets the first charge collector thereby performing a destructive read out (with signal erasing) of the first charge collector and the pixel more generally prior to starting a current integration period.

In operation 404, process 400 activates charge integration for a first charge storage element. In one embodiment, charge integration may be activated by turning on an integrating device associated with the first charge storage element (e.g., integrating device 218 or integrating device 222 of FIG. 2).

In operation 406, process 400 generates charge in response to an x-ray beam impinging a surface of a detector plane. In one embodiment, the charge may be generated by converter 204 and transferred to a charge collector (e.g., capacitor 212 via charge collection electrode 202).

In operation 408, process 400 collects the charge generated in operation 406 at the first charge collector, i.e., the charge collector activated in operation 404; and converts this charge to voltage.

In operation 410, process 400 activates a reading of a second charge collector. In one embodiment, reading may be activated by turning on a reading device (e.g., reading device 220 or reading device 224). Notably, reading may be activated prior to activating charge collection for the first charge collector in operation 404, or may be activated while collecting charge at the first charge collector.

In operation 412, while collecting the charge at the first charge collector, process 400 reads and records a pixel signal corresponding to collected charge at the second charge collector.

In operation 414, process 400 de-activates reading of the second charge collector in response to finishing reading the pixel signal. In one embodiment, reading may be de-activated by turning off a reading device (e.g., reading device 220 or reading device 224).

In optional operation 416, process 400 resets the second charge collector thereby, in conjunction with reading the second charge collector in operations 412, 414, performing a destructive read out of the second charge collector and the 2 nanosecond (ns) bank of the pixel more generally.

In cases where optional operation 416 is not performed, process 400 performs a non-destructive read-out of a charge collector and the pixel more generally. In some cases, the image data (a frame) read in process 400 may be for a final, ultimately reconstructed, image of image data. In some cases, the image data read in process 400 may be incorporated into a frame of image data analysis before the final image is generated. As a non-limiting example, multiple reads may be performed of a given pixel and then several frames are averaged to form a final frame of image data for image reconstruction (e.g., for clinical image reconstruction or inspection image reconstruction, without limitation).

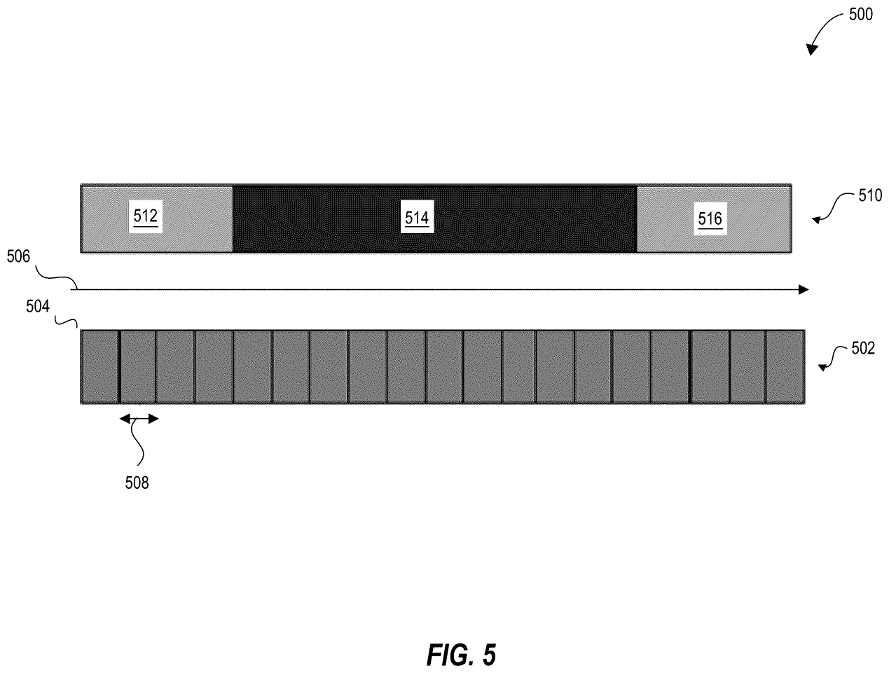

FIG. 5 illustrates a frame collection timeline 500 of an adaptive frame grabbing from pixel signals generated by pixels 304 of pixel matrix 300 by computing device 110 such that x-ray imaging system 100 is continuously “ready,” and does not require a readiness signal to synchronize an image capture to a radiation supply.

Computing device 110 may be configured to monitor the pixels of the detector plane 104 at a frame rate. Monitoring timeline 502 illustrates each frame in continuous frame set 504 with respect to time 506. Each frame may have an integration period 508 defined by a frame rate. For example, a frame rate may be, but not limited to between about 10 fps and about 60 fps, such as between about 16 fps and about 50 fps, between about 20 fps and about 40 fps, or between about 24 fps and about 35 fps. For example, the integration period 508 for each frame 504 may be, but not limited to, between about 20 milliseconds (ms) and about 60 ms, such as between about 28 ms and about 55 ms, or between about 20 ms and about 40 ms.

Radiation source timeline 510 illustrates a supply of radiation from radiation source 102 with respect to an advancing time 506. Radiation source timeline 510 may have inactive period 512 when no radiation is being supplied, and active period 514 when radiation is being supplied (radiation may be supplied in the continuous or in the pulsed manner). In some embodiments, computing device 110 may constantly read pixels (e.g., pixels 304 of FIG. 3) during inactive period 512. When active period 514 begins, computing device 110 may detect a change in a pixel gray value (e.g., a threshold change, significant change, substantial change, without limitation) corresponding to a presence of a charge (e.g., present on pixels 304 of FIG. 3) during frames 504 (i.e., during which active period 514 begins) and so a presence of radiation. The detected signal on the pixels may indicate that an x-ray image is present (e.g., image data, x-ray image data, without limitation).

In some embodiments, an optional pre-pulse of x-rays may be captured (e.g., as a pre-pulsed frame or as pre-pulsed x-ray data, without limitation) and analyzed prior to capture of a main pulse of x-rays (e.g., as a main frame, without limitation). Exposure settings that control exposure conditions of the main frame may be optionally set in response to a signal level of the pre-pulse to optimize image quality for a given object under examination. Computing device 110 may analyze a detected signal from the pixels as active period 514 begins, and optionally send feedback (e.g., via an automatic exposure control operation, without limitation) to set an exposure duration setting to the x-ray generator of the radiation source 102 to adjust an x-ray exposure condition of active period 514, to be adjusted to ensure optimal image quality.

During the active period 514 all the frames 504 and/or pixels (e.g., pixels 304 of FIG. 3) are continued to be read (destructively for 3D imaging with gantry motion or non-destructively for 2D imaging with a stationary x-ray tube) until an end of active period 514. Upon the end of active period 514, the computing device 110 may initiate a pixel reset operation (or reset of the respective charge storage capacitors) such as discussed with respect to FIG. 3, without limitation, to a pre-defined value, and begin an inactive period 516.

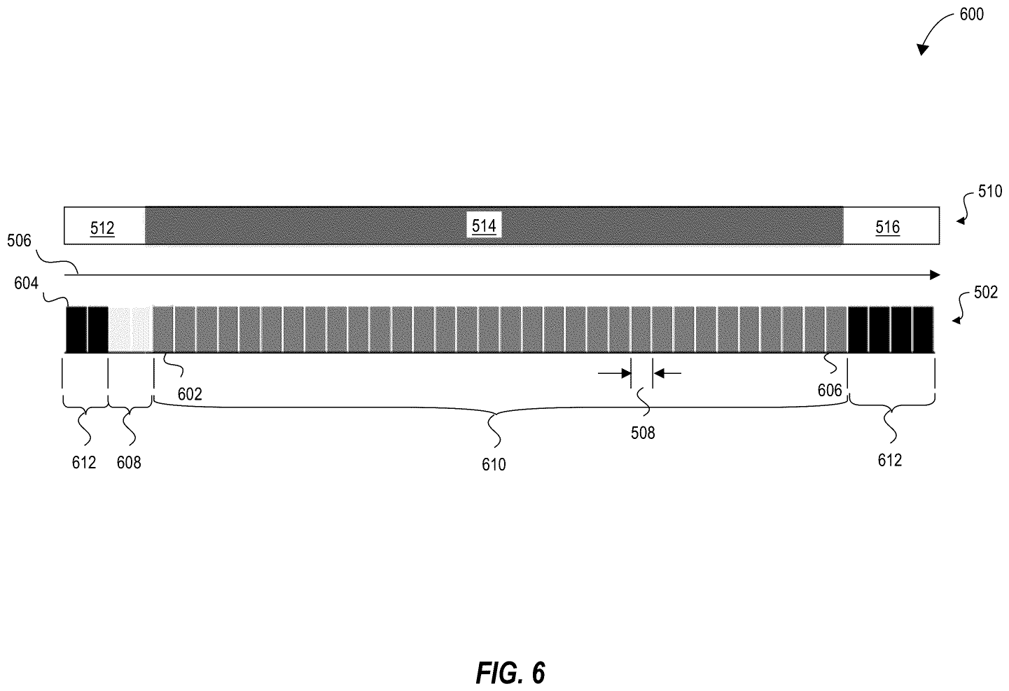

FIG. 6 is a timeline diagram depicting a frame monitoring timeline 600, in accordance with one or more embodiments. In some embodiments, computing device 110 may monitor grey values of one or more frames 604 during a frame monitoring period 612 that corresponds to an inactive period 512 of radiation source timeline 510. For example, computing device 110 may non-destructively monitor (e.g., read only, or read but not erase nor record, without limitation) during inactive period 512 with or without global periodic reset. When radiation is detected in response to a presence of a threshold signal on pixels 304, then start frame 602 may be defined (by computing device 110) to indicate a start of an x-ray image data collection. After start frame 602, computing device 110 may record frames 604 during a frame recording period 610 (e.g., capture, store, save, without limitation) by recording a charge signal (e.g., data, image data, without limitation) from the pixels 304 for each successive frame of frames 604. Recording a signal developed at pixels 304 during frame recording period 610 may be performed non-destructively and/or destructively, i.e., computing device 110 may erase (e.g., reset, destructively read, without limitation) the pixels 304 at each and/or selected frame(s) to ensure optimal image quality of the final reconstructed image.

Once the voltage on the pixels 304 drops below a lower limit of a threshold voltage or reaches an upper limit of threshold voltage, a stop frame 606 may be defined to indicate the end of the x-ray image data being collected. After the stop frame 606, the computing device 110 may return to monitoring frames 604 of the pixels 304 during a next frame monitoring period 612.

In some embodiments, computing device 110 may capture one or more frames during a frame reference period 608 (e.g., reference image data, base image data, offset image data or image data representative of the environment before the radiation source 102 is activated, without limitation) such as one reference frame, two reference frames, three reference frames, four reference frames, without limitation. Reference frames may be selected from the frames directly preceding the start frame 602. In some embodiments, reference frames may be selected from the frames directly following stop frame 606. In some embodiments, reference frames may be selected from frames both preceding a start frame 602 and following stop frame 606. Reference frames may enable the computing device 110 to define baseline data (e.g., reference image, without limitation) for determining variables such as offset, image lag, without limitation to improve at least one of image quality, contrast, uniformity, without limitation.

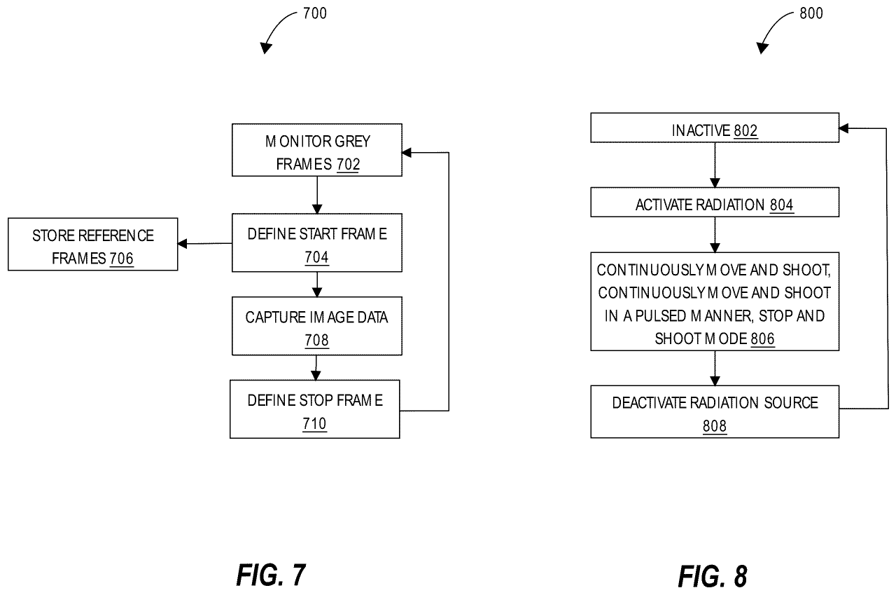

FIG. 7 and FIG. 8 are flowcharts depicting computing process 700 and x-ray delivery process 800, in accordance with one or more embodiments. FIG. 7 is a flowchart depicting an embodiment of a computing process 700 for capturing x-ray information associated with an x-ray delivery process, such as x-ray delivery process 800 depicted by FIG. 8. In some embodiments, computing process 700 of the computing device 110 may be isolated (e.g., with no signal synchronization, nor communication, without limitation) from x-ray delivery process 800 of the radiation source 102.

In some embodiments, radiation source 102 may be controlled (e.g., activated and/or deactivated) by a user (e.g., medical professional, security personnel, without limitation). In some embodiments, radiation source 102 may be automatically controlled (e.g., controlled by a proximity sensor indicating the presence of an object, controlled by a timer, and controlled by a link from preceding process or apparatus, without limitation). When radiation source 102 is not providing radiation, it may remain in an inactive state during operation 802 (e.g., idle, resting stage, off, without limitation). The radiation source 102 may be activated at operation 804. When radiation source 102 is activated it may supply radiation in a direction toward detector plane 104. Radiation source 102 may continuously supply radiation at operation 806. For example, the radiation source may continuously supply radiation for between about 1 second and about 60 seconds such as between about 2 seconds and about 30 seconds, or between about 2 seconds and about 8 seconds. Radiation source 102 may also be continuously moving along arc path 108 relative to object 106 while supplying the radiation. Once radiation source 102 reaches an end of arc path 108 and/or the radiation supply time expires, radiation source 102 may deactivate at operation 808. Radiation source may also supply radiation in a pulsed manner while continuously moving along the arc; or move, stop-and-shoot at operation 806 until it reaches the end of arc path 108. Upon deactivation, radiation source 102 may re-enter an inactive state in operation 802. In some embodiments, the radiation source 102 may return to a start point on arc path 108. In some embodiments, radiation source 102 may remain at the end of arc path 108 where the radiation source 102 was deactivated at operation 806. In some embodiments, the radiation source 102 may move along arc path 108 in the opposite direction after radiation source 102 is activated a second time at operation 804. An angle span, speed of the gantry motion, number of shoots in a pulsed case scenario may vary based on the system implementation. As discussed above, in one or more embodiments a radiation source may include multiple (e.g., two or more) stationary x-ray sources, e.g., based on cold cathode technology, without limitation, that supply radiation at various angles of incidence to an object.

In one or more embodiments, a computing device 110 may operate independent (i.e., without signals directly synchronizing one or more operations of computing process 700 and x-ray delivery process 800) of a radiation source 102. Computing device 110 may continuously monitor the pixels 310 from the array of pixels on detector plane 104 at operation 702. Computing device 110 may continuously monitor pixels 310 for a period of time during operation 702 (e.g., until the computing device 110 moves on to operation 704, as described below). In some embodiments, the computing device 110 may monitor pixels 310 by reading pixels 310 in a non-destructive manner (e.g., without erasing pixels 310 voltage). In some embodiments, computing device 110 may monitor pixels 310 by only reading and not recording the digitized e.g., data, information, without limitation developed on pixels 310. In some embodiments, computing device 110 may monitor pixels 310 grey value by only recording the signal for the pixels 310 from a limited number of the frames, such as between about 1 frame and about 10 frames, or between about 2 frames and about 4 frames. For example, computing device 110 may begin overwriting the data recorded for the oldest frame set with the data from the most recent frame set.

When computing device 110 detects a threshold change in the pixel voltage on one or more of the pixels 310, computing device 110 may define a start frame 602 at operation 704. In some embodiments, a circuit, such as a buffer may separately monitor the signal level on the pixels and only output data to the computing device if the threshold value is met.

The threshold charge of a pixel of pixels 310 may vary depending on the environment and/or application. In some embodiments, the threshold charge may be between about 1 fC and 50 fC, between about 50 fC and 500 fC, without limitation. Any suitable x-ray pulses may be used to detect a start frame without exceeding the scope of this disclosure, for example, a pre-pulse of x-rays generated for automatic exposure control (AEC) or a main pulse of x-rays with or without AEC.

Computing device 110 may record available frames (e.g., the number of the frames that are recorded during the monitoring stage at operation 702) preceding start frame 602, i.e., during frame reference period 608, as frames for the x-ray image data that will begin at start frame 602 at operation 708. After start frame 602, the computing device 110 may capture (e.g., destructively read and record by erasing each pixels 310 voltage after reading and recording the image data from pixels 310 at each frame during operation 708 or non-destructively in the case of 2D imaging); can also be non-destructively combined with destructive readout once full scale capacity is approaching. Once computing device 110 detects an absence of radiation (stated another way, a loss of supply of radiation) by detecting the charge of the pixels 310 value dropping below a threshold charge value (e.g., for 3D imaging, without limitation) or remaining at the unchanged value (e.g., for 2D imaging, without limitation) either by computing device 110 or the aforementioned buffer, computing device 110 may define stop frame 606 at operation 710.

After stop frame 606 is defined, computing device 110 may return to continuously monitoring pixel 200 signal level at operation 702. The image data recorded between the start frame 602 and the stop frame 606 during operation 706 may be compiled by computing device 110. The image data from each individual frame set 504 may be used for reconstruction together with the image data from the other frame set 504. The reconstruction algorithms may account for an angle at which each frame was acquired based on the time required for the radiation source 102 to travel across the arc path 108, and, in the case of stationary radiation sources, a position of the respective radiation sources. In some embodiments, radiation source 102 may include an angle encoder system configured to output angle values at the end of a scan. The angle values may then be associated with the respective frame set 504 to determine the correct in/out parameters of each frame in the set of image data used for reconstruction. Once the image data from each frame are correctly processed, a three-dimensional representation of the object 106 may be digitally forming a digital tomography image.

The three-dimensional representation may allow a reader (e.g., medical professional, security personnel, without limitation) to see masses (e.g., tumors, cists, without limitation), objects (e.g., weapons, contraband, without limitation), or other potentially interesting or concerning items (e.g., fractures, medical instruments, leaks, ruptures, without limitation) that may otherwise be hidden from view in a conventional two-dimensional x-ray image.

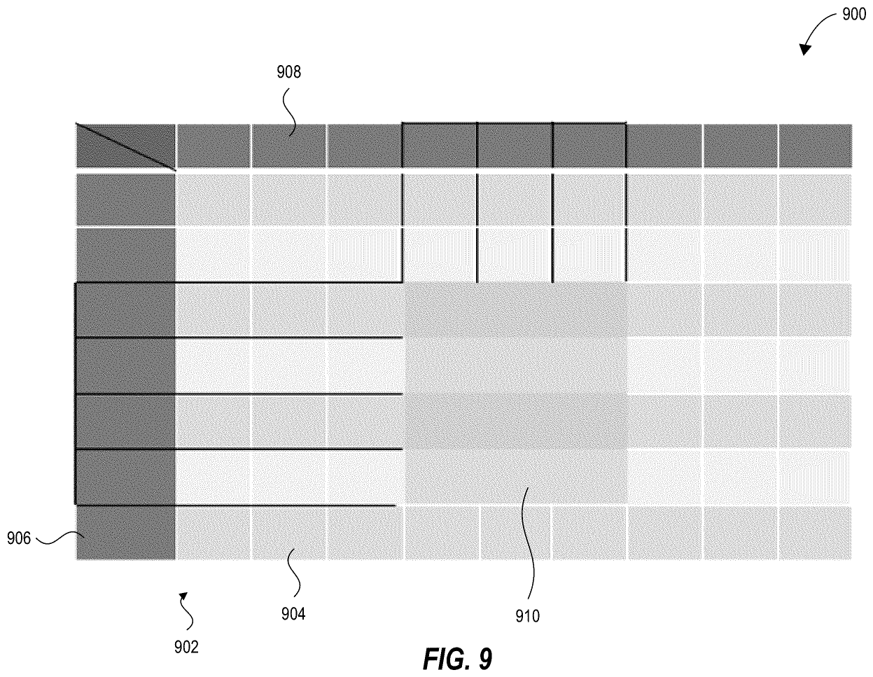

FIG. 9 illustrates an embodiment of a pixel array 900 of a subset of pixels 902, according to various embodiments of the present disclosure. The position (e.g., address, location, without limitation) of each pixel 904 may be defined by a combination of a row 906 and a column 908 coordinates. The computing device 110 (FIG. 1) may use the position when organizing the image data gathered from each pixel 904. In some embodiments, the computing device 110 (FIG. 1) may associate (e.g., bin, couple, correlate, without limitation) more than one (e.g., two, four, six, eight, twelve, sixteen, twenty, without limitation) pixels with a single charge voltage value (e.g., electrode, input, read, without limitation). For example, when more than one pixel 904 is associated with a single value, the data read may be an average or combined value of the more than one pixel 904 of pixels 902.

In some embodiments, the computing device 110 (FIG. 1) may be programmed to inactively monitor only a subset of pixels of pixels 902, in the specific non-limiting example depicted by FIG. 9, the pixels of pixels 902 that are located in regions of interest 910. In some embodiments, the computing device 110 (FIG. 1) may define multiple regions of interest 910 in different positions throughout the detector plane 104. For example, when inactively monitoring the pixel array 900 of pixels 902, the computing device 110 (FIG. 1) may monitor multiple pixels 902 in each region of interest 910 through a single output for each region of interest 910. When the average charge signal at the output from at least one of the regions of interest 910 passes a threshold value, the computing device 110 (FIG. 1) may trigger a start frame and begin monitoring all pixels 902 in the pixel array 900 individually. In some embodiments, a predefined number of regions of interest 910 (e.g., two, three, four, without limitation) may be required to pass the threshold value to avoid a false positive (e.g., false start). For example, the region of interest 910 may be positioned in an area where higher radiation is expected during a scan, such as, e.g., a corner of the pixel array 900 where the object 106 (FIG. 1) position is not expected to cover all of the pixels (e.g., such that at least some radiation is expected to impinge directly on the pixels in a region of the regions of interest 910 without passing through the object 106 (FIG. 1)).

In some embodiments, the regions of interest 910 may be adjacent each other and cover substantially the entire pixel array 900. For example, the computing device 110 (FIG. 1) may substantially monitor the entire pixel array 900 at a lower resolution, because rather than monitoring each individual pixel 904 of the array, the computing device 110 (FIG. 1) would be monitoring average or combined signals of multiple pixels 902 in each adjacent region of interest 910. In some embodiments, the regions of interest 910 may only represent a subset of pixels 902. For example, the regions of interest 910 may only represent ½ of the total pixels 902, ⅓ of the total pixels 902, or ¼ of the total pixels 902.

Monitoring regions of interest 910 rather than each pixel 904 individually reduces processing power, memory usage, processing time, substantially increase a frame rate without limitation required by the computing device 110 (FIG. 1) during the inactive monitoring mode. The computing device 110 (FIG. 1) may still read and record the charge from each pixel 904 individually during the active monitoring phase maintaining high resolution in images usable for the scan, while utilizing efficient, low energy consumption, methods when inactive.

An x-ray imaging system that is always ready and is able to continuously shoot and move may significantly simplify detector implementation and reduce scan duration. High frame rate of such system may result in improved image quality, e.g., reduced geometrical blur, noise, and/or blind spots. Increased image quality may allow a user to see and/or diagnose problems that might otherwise be missed such as cancerous growths that might otherwise be hidden from view by other items, masses, glands, scar tissue, or the distortion and noise itself. Such improvements in accuracy may improve medical screenings, for example, in early detection of cancer via cancer screenings or mammograms. Such improvements in accuracy may also improve security screenings through increasing the speed and accurate flagging of items of interest.

Decreased scan duration may also result from the elimination of synchronization signal/transmissions between the radiation source and the detector plane or computing device. Quicker scans may improve the comfort of patients as well as minimize motion blur when subjected to x-ray image screening due to decreased amount of time of the patient or a part of the patient may be immobile within the x-ray imaging device. Increased speed may also result in higher throughput and reduced time in security screening reducing delays in airports and at events, for example.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). As used herein, “each” means some or a totality. As used herein, “each and every” means a totality.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting embodiments of the disclosure include:

Embodiment 1: an x-ray imaging system comprising: a radiation source configured to transmit radiation toward an object; a number of pixels arranged to detect radiation transmitted through the object; and a computing device configured to: monitor a pixel or subset of the number of pixels until the radiation is detected; and begin an examination in response to the radiation being detected.

Embodiment 2: the x-ray imaging system according to Embodiment 1, wherein the computing device is configured to: capture image data from the number of pixels responsive to radiation being detected until no radiation is detected; and continue to monitor the number of pixels or subset of the number of pixels responsive to no radiation being detected.

Embodiment 3: the x-ray imaging system according to Embodiments 1 and 2, wherein the number of pixels are individually coupled to a respective electrode.

Embodiment 4: the x-ray imaging system according to Embodiments 1 through 3, wherein the number of pixels comprise pixels coupled to X-ray-to-charge converters.

Embodiment 5: the x-ray imaging system according to Embodiments 1 through 4, wherein each pixel of the number of pixels comprises: a photoconductor coupled to an electrode; a programmable and selectable set of capacitors coupled to the electrode; and transistor switches operable to initiate reset, integration and readout of a signal from a capacitor of the programmable and selectable set of capacitors.

Embodiment 6: the x-ray imaging system according to Embodiments 1 through 5, wherein the pixels comprise two-stage pixels.

Embodiment 7: the x-ray imaging system according to Embodiments 1 through 6, wherein each stage of the two-stage pixels comprises a separate programmable capacitor and at least three switches operable to initiate reset, enable charge integration, and signal readout.

Embodiment 8: the x-ray imaging system according to Embodiments 1 through 7, wherein the computing device is configured to capture image data at a frame rate between about 10 fps and about 60 fps.

Embodiment 9: the x-ray imaging system according to Embodiments 1 through 8, wherein a synchronization signal indicating readiness for signal integration between the radiation source and a number of pixels or the computing device is not needed.

Embodiment 10: the x-ray imaging system according to Embodiments 1 through 9, wherein the radiation source is communicatively de-coupled from one or both of the number of pixels and the computing device.

Embodiment 11: a method of capturing x-ray images for two-dimensional and/or three-dimensional imaging applications, the method comprising: monitoring a number of pixels, non-destructively or destructively, at a frame rate; detecting a presence of radiation at the number of pixels; capturing and recording image data from an array of pixels including the number of pixels; erasing the image data from the array of pixels after the image data is captured and recorded; detecting an absence of radiation in the array of pixels; and monitoring the number of pixels, non-destructively or destructively, after detecting the absence of radiation.

Embodiment 12: the method according to Embodiment 11, further comprising binning the number of pixels when the number of pixels are being monitored non-destructively or destructively.

Embodiment 13: the method according to Embodiments 11 and 12, wherein binning the number of pixels comprises coupling an output of at least two pixels to a single output and monitoring a single output representative of the at least two pixels.

Embodiment 14: the method according to Embodiments 11 through 13, wherein binning the number of pixels comprises coupling an output of at least four pixels to a single output and monitoring a single output representative of the at least four pixels.

Embodiment 15: the method according to Embodiments 11 through 14, further comprising capturing reference image data from the array of pixels from at least one frame before detecting the presence of radiation.

Embodiment 16: the method according to Embodiments 11 through 15, further comprising correcting the image data for offset using the reference image data, wherein the offset comprises one or more of lag offset or residual signal offset.

Embodiment 17: a non-transitory computer-readable medium having executable instructions stored thereon that, in response to being executed by a processor of a system for two-dimensional or three-dimensional imaging, are configured to enable the system to perform, or control performance of, operations, the operations comprising: monitoring a number of pixels, non-destructively or destructively, at a frame rate; detecting a presence of radiation at the number of pixels; capturing and recording image data from an array of pixels including the number of pixels; erasing the image data from the array of pixels after the image data is captured and recorded; detecting an absence of radiation in the array of pixels; and monitoring the number of pixels, non-destructively or destructively, after detecting the absence of radiation.

Embodiment 18: the non-transitory computer-readable medium according to Embodiment 17, the operations further comprising capturing reference imaging data from a subset of pixels for at least one frame before identifying the presence of radiation.

Embodiment 19: the non-transitory computer-readable medium according to Embodiments 17 and 18, the operations further comprising defining a reference image using reference imaging data from a subset of pixels.

Embodiment 20: the non-transitory computer-readable medium according to Embodiments 17 through 19, the operations further comprising correcting the image data for offset responsive to the reference image, wherein the offset includes one or more of lag or residual signal from a previous frame.

Embodiment 21: the non-transitory computer-readable medium according to Embodiments 17 through 20, the operations further comprising: interpreting data received from a subset of pixels of the array of pixels at a first exposure setting; interpreting captured image data received from pixels of the array of pixels at a second exposure setting; and interpreting data received from the subset of pixels of a pixel array at a third exposure setting responsive to detecting the absence of radiation.

Embodiment 22: the non-transitory computer-readable medium according to Embodiments 17 through 21, the operations further comprising interpreting captured imaging data and providing information about identified radiation to an automatic exposure control operation to adjust an exposure duration setting.

Embodiment 23: the non-transitory computer-readable medium according to Embodiments 17 through 22, wherein the first exposure setting and the third exposure setting correspond to respective resolutions that are lower than a resolution of the second exposure setting.

Embodiment 24: the non-transitory computer-readable medium according to Embodiments 17 through 23, the operations further comprising interpreting the data received from the subset of pixels of the pixel array at the third exposure setting without capturing the data.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated by the inventors.

1. An x-ray imaging system comprising:
a radiation source configured to transmit radiation toward an object;
a number of pixels arranged to detect radiation transmitted through the object; and
a computing device configured to:
monitor a pixel or subset of the number of pixels until the radiation is detected; and
begin an examination in response to the radiation being detected.

2. The x-ray imaging system of claim 1, wherein the computing device is configured to:
capture image data from the number of pixels responsive to radiation being detected until no radiation is detected; and
continue to monitor the number of pixels or subset of the number of pixels responsive to no radiation being detected.

3. The x-ray imaging system of claim 1, wherein the number of pixels are individually coupled to a respective electrode.

4. The x-ray imaging system of claim 1, wherein the number of pixels comprise pixels coupled to X-ray-to-charge converters.

5. The x-ray imaging system of claim 4, wherein each pixel of the number of pixels comprises:
a photoconductor coupled to an electrode;
a programmable and selectable set of capacitors coupled to the electrode; and
transistor switches operable to initiate reset, integration and readout of a signal from a capacitor of the programmable and selectable set of capacitors.

6. The x-ray imaging system of claim 4, wherein the pixels comprise two-stage pixels.

7. The x-ray imaging system of claim 6, wherein each stage of the two-stage pixels comprises a separate programmable capacitor and at least three switches operable to initiate reset, enable charge integration, and signal readout.

8. The x-ray imaging system of claim 1, wherein the computing device is configured to capture image data at a frame rate between about 10 fps and about 60 fps.

9. The x-ray imaging system of claim 1, wherein a synchronization signal indicating readiness for signal integration between the radiation source and a number of pixels or the computing device is not needed.

10. The x-ray imaging system of claim 1, wherein the radiation source is communicatively de-coupled from one or both of the number of pixels and the computing device.

11. A method of capturing x-ray images for two-dimensional and/or three-dimensional imaging applications, the method comprising:
monitoring a number of pixels, non-destructively or destructively, at a frame rate;
detecting a presence of radiation at the number of pixels;
capturing and recording image data from an array of pixels including the number of pixels;
erasing the image data from the array of pixels after the image data is captured and recorded;
detecting an absence of radiation in the array of pixels; and
monitoring the number of pixels, non-destructively or destructively, after detecting the absence of radiation.

12. The method of claim 11, further comprising binning the number of pixels when the number of pixels are being monitored non-destructively or destructively.

13. The method of claim 12, wherein binning the number of pixels comprises coupling an output of at least two pixels to a single output and monitoring a single output representative of the at least two pixels.

14. The method of claim 12, wherein binning the number of pixels comprises coupling an output of at least four pixels to a single output and monitoring a single output representative of the at least four pixels.

15. The method of claim 11, further comprising capturing reference image data from the array of pixels from at least one frame before detecting the presence of radiation.

16. The method of claim 15, further comprising correcting the image data for offset using the reference image data, wherein the offset comprises one or more of lag offset or residual signal offset.

17. A non-transitory computer-readable medium having executable instructions stored thereon that, in response to being executed by a processor of a system for two-dimensional or three-dimensional imaging, are configured to enable the system to perform, or control performance of, operations, the operations comprising:
monitoring a number of pixels, non-destructively or destructively, at a frame rate;
detecting a presence of radiation at the number of pixels;
capturing and recording image data from an array of pixels including the number of pixels;
erasing the image data from the array of pixels after the image data is captured and recorded;
detecting an absence of radiation in the array of pixels; and
monitoring the number of pixels, non-destructively or destructively, after detecting the absence of radiation.

18. The non-transitory computer-readable medium of claim 17, the operations further comprising capturing reference imaging data from a subset of pixels for at least one frame before identifying the presence of radiation.

19. The non-transitory computer-readable medium of claim 17, the operations further comprising defining a reference image using reference imaging data from a subset of pixels.

20. The non-transitory computer-readable medium of claim 19, the operations further comprising correcting the image data for offset responsive to the reference image, wherein the offset includes one or more of lag or residual signal from a previous frame.

21. The non-transitory computer-readable medium of claim 17, the operations further comprising:
interpreting data received from a subset of pixels of the array of pixels at a first exposure setting;
interpreting captured image data received from pixels of the array of pixels at a second exposure setting; and
interpreting data received from the subset of pixels of a pixel array at a third exposure setting responsive to detecting the absence of radiation.

22. The non-transitory computer-readable medium of claim 21, the operations further comprising interpreting captured imaging data and providing information about identified radiation to an automatic exposure control operation to adjust an exposure duration setting.

23. The non-transitory computer-readable medium of claim 21, wherein the first exposure setting and the third exposure setting correspond to respective resolutions that are lower than a resolution of the second exposure setting.

24. The non-transitory computer-readable medium of claim 21, the operations further comprising interpreting the data received from the subset of pixels of the pixel array at the third exposure setting without capturing the data.
